(19) United States
(12) Patent Application Publication
(10) Pub. No.: US 2022/0036411 A1
(43) Pub. Date: Feb. 3, 2022

(54) METHOD AND SYSTEM FOR JOINT OPTIMIZATION OF PRICING AND COUPONS IN RIDE-HAILING PLATFORMS

(71) Applicant: Beijing DiDi Infinity Technology and Development Co., Ltd., Beijing (CN)

(72) Inventors: Bo TAN, Sunnyvale, CA (US); Ye CHEN, Pleasanton, CA (US); Yanyi HE, Sunnyvale, CA (US)

(21) Appl. No.: 16/944,843

(22) Filed: Jul. 31, 2020

(51) Int. Cl. G06Q 30/02; G06Q 10/06; G06Q 10/04; G06Q 10/02; G06Q 50/30; G06N 20/00; G06F 17/18

(52) U.S. Cl. CPC G06Q 30/0283; G06Q 30/0211; G06Q 10/06393; G06F 17/18; G06Q 10/02; G06Q 50/30; G06N 20/00; G06Q 10/04

(57) ABSTRACT

Methods, systems, and apparatus, including computer programs encoded on computer storage media, for joint optimization of price multipliers and coupons in a ride-hailing platform are disclosed. An exemplary method comprises: obtaining a plurality of spatial-temporal pricing units and a plurality of rider segments; constructing a plurality of key performance indicator (KPI) metrics, wherein each of the KPI metrics takes input comprising (1) the price adjustment multiplier applied to a given trip and (2) the rider coupon applied to a rider of the given trip, and generates output comprising a KPI value of the given trip; constructing an optimization problem that maximizes a weighted sum of the plurality of KPI metrics with a vector of price-adjustment-multiplier decision variables and a matrix of rider-coupon decision variables; and determining, by solving the optimization problem, a plurality of optimal price adjustment multipliers and a plurality of optimal rider coupons.

### TECHNICAL FIELD

The disclosure relates generally to systems and methods for jointly optimizing pricing and coupons in ride-hailing platforms, in particular, jointly determining optimal price adjustment multipliers and personalized coupons in a ride-hailing environment.

### BACKGROUND

On-demand ride-hailing services have seen rapid expansion in recent years. In a ride-hailing platform, the rider price is an “upfront” price, which factors in estimated travel time and distance, supply/demand balance (e.g., as surge multipliers), price adjustment multipliers, and various surcharges and fees. The ride-hailing platform may also apply personalized coupons as another lever in determining the final prices for riders. It often subsidizes riders to incentivize their engagement with the platform. In the state-of-the-art approaches, the price adjustment multipliers and personalized coupons are often determined separately as two independent factors in pricing strategies. However, these two factors are both related to financial budget (since coupons and price adjustment multipliers may offset each other's effectiveness, and may both be subsidies when the price adjustment multipliers are less than one). Therefore, it is desirable to jointly determining the optimal price adjustment multipliers and personalized coupons for pricing the trips.

### SUMMARY

Various embodiments of the present specification may include systems, methods, and non-transitory computer-readable media for jointly optimizing price adjustment multipliers and coupons for a ride-hailing platform.

According to one aspect, the method for jointly optimizing price adjustment multipliers and coupons for a ride-hailing platform comprises: obtaining a plurality of spatial-temporal pricing units and a plurality of rider segments, wherein each of the plurality spatial-temporal pricing units corresponds to a price adjustment multiplier applicable to trips that occur within the spatial-temporal pricing unit, and each of the plurality of rider segments corresponds to a rider coupon applicable to a rider in the rider segment; constructing a plurality of key performance indicator (KPI) metrics, wherein each of the KPI metrics takes input comprising (1) the price adjustment multiplier applied to a given trip and (2) the rider coupon applied to a rider of the given trip, and generates output comprising a KPI value of the given trip, wherein the price adjustment multiplier and the rider coupon are factors in determining a price for the given trip; constructing an optimization problem that maximizes a weighted sum of the plurality of KPI metrics with a vector of price-adjustment-multiplier decision variables and a matrix of rider-coupon decision variables, each of the price-adjustment-multiplier decision variables corresponding to one of the plurality of spatial-temporal pricing units, and each of the rider-coupon decision variables respectively corresponding to one of the plurality of rider segments within one of the plurality of spatial-temporal pricing units; determining, by solving the optimization problem, a plurality of optimal price adjustment multipliers and a plurality of optimal rider coupons; and deploying the plurality of optimal price adjustment multipliers and the plurality of optimal rider coupons in the ride-hailing platform to determine trip prices.

In some embodiments, the obtaining a plurality of rider segments comprises: obtaining a plurality of rider segmentation results by respectively applying a plurality of clustering methods to segment a plurality of historical riders based on a plurality of rider features; for each of the plurality of rider segmentation results, obtaining an evaluation score based on a weighted sum of a plurality of evaluation metrics; and identifying one of the plurality of clustering methods corresponding to a smallest evaluation score; and deploying the identified clustering method to segment new riders.

In some embodiments, each of the plurality of rider segmentation results comprise a plurality of historical rider segments, and the plurality of evaluation metrics comprise a mean price elasticity metric that measures price elasticity of each of the plurality of rider segmentation results by: for each of the plurality of historical rider segments in the each rider segmentation result: dividing a plurality of historical requests from riders in the each rider segment into a plurality of price bins based on prices shown to the rider; obtaining a conversion rate for each of the plurality of price bins, wherein the conversion rate represents a percentage of the historical requests in the each price bin that have converted to trips; and obtaining a price elasticity based on the plurality of price bins of the each historical rider segment and the plurality of corresponding conversion rates; and for each of the plurality of rider segmentation results, determining the mean price elasticity difference based on the plurality of price elasticities of the plurality of historical rider segments in the each rider segmentation result.

In some embodiments, the plurality of clustering methods are determined by: determining a plurality of feature selection methods; determining a plurality of distance metrics to measure clustering distances between the riders; determining a plurality of clustering algorithms; and obtaining the plurality of clustering methods as a plurality of combinations of the plurality of feature selection methods, the plurality of distance metrics, and the plurality of clustering algorithms.

In some embodiments, the plurality of rider features comprise: a rider's historical trip information comprising at least one of the following: an average trip price, an average surge of completed trips, an average coupon of the completed trips, a percentage of converted sessions; and the rider's personal information comprising at least one of the following: a number of years the rider has been using the ride-hailing platform, frequent payment methods, and information of the rider's smart device.

In some embodiments, the plurality of evaluation metrics comprise a Silhouette score measuring a similarity of a rider to other riders in a same historical rider segment as compared to riders in a different historical rider segment.

In some embodiments, the plurality of key performance indicator (KPI) metrics comprises at least two of the following: a trip conversion rate metric, a gross profit metric, and a gross merchandise value metric.

In some embodiments, the trip conversion rate metric comprises a trained classification-type machine learning model that predicts a probability that a rider's request converts to a trip based at least on the price adjustment multiplier and the rider coupon applied to the request.

In some embodiments, the rider coupon is a discount amount or a discount percentage.

In some embodiments, the solving the optimization problem comprises: parallelly determining values of the plurality of KPI metrics for each of the plurality of spatial-temporal pricing units with a parallel-programming architecture.

In some embodiments, the parallel-programming architecture comprises at least one of the following: a Spark framework, a Metacomputer Adaptive Runtime System (MARS) framework, a map reduce framework, and one or more GPUs.

According to another aspect, a system for jointly optimizing price adjustment multipliers and coupons for a ride-hailing platform may comprise one or more processors and one or more non-transitory computer-readable memories coupled to the one or more processors and configured with instructions executable by the one or more processors to cause the system to perform operations comprising: obtaining a plurality of spatial-temporal pricing units and a plurality of rider segments, wherein each of the plurality spatial-temporal pricing units corresponds to a price adjustment multiplier applicable to trips that occur within the spatial-temporal pricing unit, and each of the plurality of rider segments corresponds to a rider coupon applicable to a rider in the rider segment; constructing a plurality of key performance indicator (KPI) metrics, wherein each of the KPI metrics takes input comprising (1) the price adjustment multiplier applied to a given trip and (2) the rider coupon applied to a rider of the given trip, and generates output comprising a KPI value of the given trip, wherein the price adjustment multiplier and the rider coupon are factors in determining a price for the given trip; constructing an optimization problem that maximizes a weighted sum of the plurality of KPI metrics with a vector of price-adjustment-multiplier decision variables and a matrix of rider-coupon decision variables, each of the price-adjustment-multiplier decision variables corresponding to one of the plurality of spatial-temporal pricing units, and each of the rider-coupon decision variables respectively corresponding to one of the plurality of rider segments within one of the plurality of spatial-temporal pricing units; determining, by solving the optimization problem, a plurality of optimal price adjustment multipliers and a plurality of optimal rider coupons; and deploying the plurality of optimal price adjustment multipliers and the plurality of optimal rider coupons in the ride-hailing platform to determine trip prices.

According to yet another aspect, a non-transitory computer-readable storage medium for jointly optimizing price adjustment multipliers and coupons for a ride-hailing platform, may be configured with instructions executable by one or more processors to cause the one or more processors to perform operations comprising: obtaining a plurality of spatial-temporal pricing units and a plurality of rider segments, wherein each of the plurality spatial-temporal pricing units corresponds to a price adjustment multiplier applicable to trips that occur within the spatial-temporal pricing unit, and each of the plurality of rider segments corresponds to a rider coupon applicable to a rider in the rider segment; constructing a plurality of key performance indicator (KPI) metrics, wherein each of the KPI metrics takes input comprising (1) the price adjustment multiplier applied to a given trip and (2) the rider coupon applied to a rider of the given trip, and generates output comprising a KPI value of the given trip, wherein the price adjustment multiplier and the rider coupon are factors in determining a price for the given trip; constructing an optimization problem that maximizes a weighted sum of the plurality of KPI metrics with a vector of price-adjustment-multiplier decision variables and a matrix of rider-coupon decision variables, each of the price-adjustment-multiplier decision variables corresponding to one of the plurality of spatial-temporal pricing units, and each of the rider-coupon decision variables respectively corresponding to one of the plurality of rider segments within one of the plurality of spatial-temporal pricing units; determining, by solving the optimization problem, a plurality of optimal price adjustment multipliers and a plurality of optimal rider coupons; and deploying the plurality of optimal price adjustment multipliers and the plurality of optimal rider coupons in the ride-hailing platform to determine trip prices.

These and other features of the systems, methods, and non-transitory computer-readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

FIG. 1 illustrates an exemplary system to which jointly determining optimal price adjustment multipliers and personalized coupons in a ride-hailing platform may be applied, in accordance with various embodiments.

FIG. 2 illustrates an exemplary diagram for segmenting riders for jointly determining optimal price adjustment multipliers and personalized coupons in a ride-hailing platform in accordance with various embodiments.

FIG. 3 illustrates an exemplary optimization problem formulation for jointly determining optimal price adjustment multipliers and personalized coupons in a ride-hailing platform in accordance with various embodiments.

FIG. 4 illustrates an exemplary flow chart of a method for jointly determining optimal price adjustment multipliers and personalized coupons in a ride-hailing platform in accordance with various embodiments.

FIG. 5 illustrates an exemplary method for jointly determining optimal price adjustment multipliers and personalized coupons in a ride-hailing platform in accordance with various embodiments.

FIG. 6 illustrates a block diagram of a computer system in which any of the embodiments described herein may be implemented.

### DETAILED DESCRIPTION

Specific, non-limiting embodiments of the present invention will now be described with reference to the drawings. It should be understood that particular features and aspects of any embodiment disclosed herein may be used and/or combined with particular features and aspects of any other embodiment disclosed herein. It should also be understood that such embodiments are by way of example and are merely illustrative of a small number of embodiments within the scope of the present invention. Various changes and modifications obvious to one skilled in the art to which the present invention pertains are deemed to be within the spirit, scope and contemplation of the present invention as further defined in the appended claims.

Price adjustment multipliers and personalized coupons are competing and complementary levers in determining the final price for a ride in a ride-hailing platform. The price adjustment multipliers may be determined automatically (e.g., by pricing algorithms) or manually (e.g., strategy/planning teams or local operation teams often take the responsibility), and the determination is usually based on objective factors like consumer price sensitivity and carpool matching rates, or even subjective opinions. Some approaches for automatically determining price adjustment multipliers may use machine learning methods and mathematical optimization techniques to compute the price adjustment multipliers across algorithmically divided spatial-temporal clusters (or route-temporal clusters, where a route is pair of spatial units). The vector of price adjustment multipliers may be obtained by solving an optimization problem that targets at maximizing core business metrics like trips and profits, with certain constraints. In this specification, the term “optimization problem” and the term “optimization model” are used interchangeably to refer a computational problem with an objective function and one or more constraints, and solving the computational problem may find the best of all possible solutions.

The “personalized coupons” are often used to subsidize riders to provide incentives for them to engage with the ride-hailing platform. Coupons may be personalized and may be regarded as a gift to a particular user. Some approaches for determining rider coupons may assume the price adjustment multipliers have already been determined and use them as constants rather than variables. However, the dynamics between the price adjustment multipliers and the rider coupons may be mistakenly omitted and ignored in these approaches.

This specification discloses methods, systems, and storage medium to algorithmically seek optimal price adjustment multipliers and personalized coupons in a joint manner for each eyeball session for each rider. Here, an “eyeball session” may refer to a sequence of information provided to a rider by the ride-hailing platform, e.g., route options, final prices, multipliers (some multipliers may be shown to drivers but not riders), and coupons. The advantages of joint optimization (as compared to individually computing price adjustment multipliers in some optimization and generating personalized coupons using some algorithms) include the following: the financial budget is considered as a whole, and the competing and complementary relationship between the price adjustment multipliers and coupons are fully learned and considered together in determining the pricing strategy.

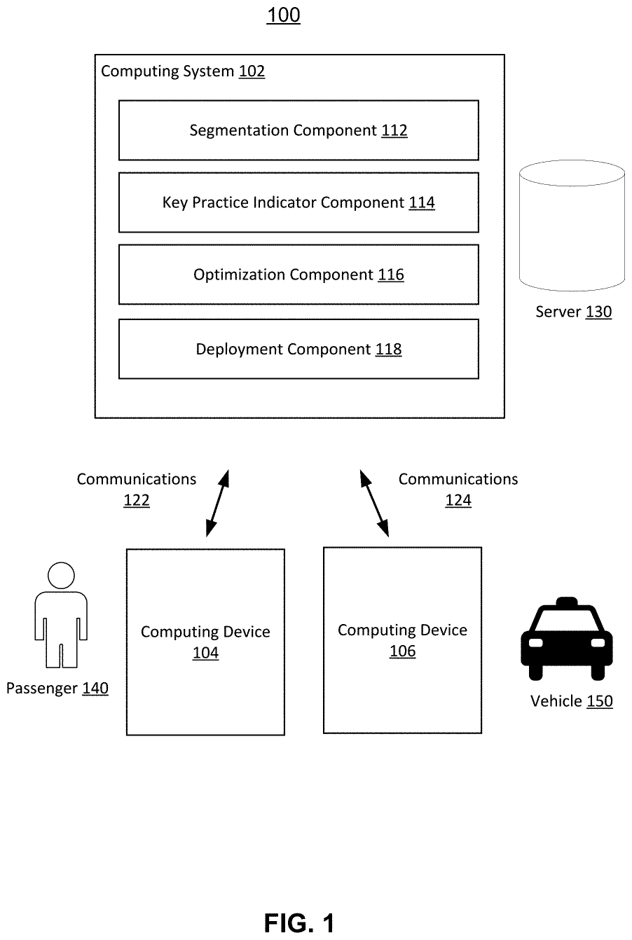

FIG. 1 illustrates an exemplary system 100 to which jointly determining optimal price adjustment multipliers and personalized coupons in a ride-hailing platform may be applied, in accordance with various embodiments. The exemplary system 100 may include a computing system 102, a computing device 104, and a computing device 106. It is to be understood that although two computing devices are shown in FIG. 1, any number of computing devices may be included in the system 100. Computing system 102 may be implemented in one or more networks (e.g., enterprise networks), one or more endpoints, one or more servers, or one or more clouds. A server may include hardware or software which manages access to a centralized resource or service in a network. A cloud may include a cluster of servers and other devices that are distributed across a network.

The computing devices 104 and 106 may be implemented on or as various devices such as a mobile phone, tablet, server, desktop computer, laptop computer, vehicle (e.g., car, truck, boat, train, autonomous vehicle, electric scooter, electric bike), etc. The computing system 102 may communicate with the computing devices 104 and 106, and other computing devices. Computing devices 104 and 106 may communicate with each other through computing system 102, and may communicate with each other directly. Communication between devices may occur over the Internet, through a local network (e.g., LAN), or through direct communication (e.g., BLUETOOTH™, radio frequency, infrared).

In some embodiments, the system 100 may include a ride-hailing platform. The ride-hailing platform may facilitate transportation service by connecting drivers of vehicles with passengers. The platform may accept requests for transportation from passengers, identify idle vehicles to fulfill the requests, arrange for pick-ups, and process transactions. For example, passenger 140 may use the computing device 104 to order a trip. The trip order may be included in communications 122. The computing device 104 may be installed with a software application, a web application, an API, or another suitable interface associated with the ride-hailing platform.

While the computing system 102 is shown in FIG. 1 as a single entity, this is merely for ease of reference and is not meant to be limiting. One or more components or one or more functionalities of the computing system 102 described herein may be implemented in a single computing device or multiple computing devices. In some embodiments, the computing system 102 may include a segmentation component 112, a key practice indicator (KPI) component 114, an optimization component 116, and a deployment component 118. Depending on the implementation, the computing system 102 may include more, fewer, or alternative components.

In some embodiments, the segmentation component 112 may be configured to obtain a plurality of spatial-temporal pricing units and a plurality of rider segments, wherein each of the plurality spatial-temporal pricing units corresponds to a price adjustment multiplier applicable to trips that occur within the spatial-temporal pricing unit, and each of the plurality of rider segments corresponds to a rider coupon applicable to a rider in the rider segment. Here, rides/trips within the same spatial-temporal pricing unit may have the same price adjustment multiplier (e.g., the spatial-temporal pricing units and price adjustment multipliers are one-to-one mapped); and the riders within the same rider segment may enjoy the same coupon options. As a result, the riders from the same rider segment and within the same pricing unit may have the same price adjustment multiplier and the same coupon options. In some embodiments, a pricing unit may be an OT unit (“O” refers to the origin of a trip, “T” refers to the time of the trip), or an ODT unit (“D” refers to the destination of the trip). The spatial-temporal pricing unit segmentation may be determined by, for example, spatial-temporal clustering algorithms, empirical evidence, or rule-based methods.

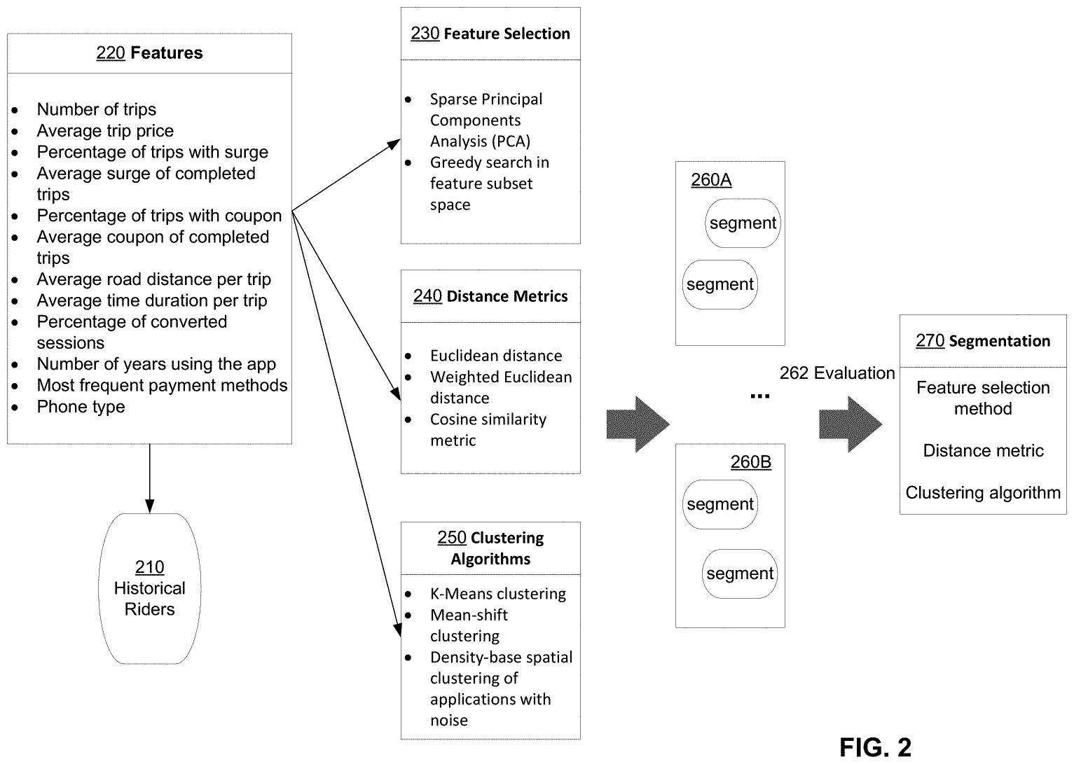

In some embodiments, the rider segmentation may be accomplished by clustering methods with evaluation mechanisms. One exemplary method may include obtaining a plurality of rider segmentation results by respectively applying a plurality of clustering methods to segment a plurality of historical riders based on a plurality of rider features; for each of the plurality of rider segmentation results, obtaining an evaluation score based on a weighted sum of a plurality of evaluation metrics; and identifying one of the plurality of clustering methods corresponding to the smallest evaluation score; and deploying the identified clustering method to segment new riders. One embodiment of a method for segmenting riders is illustrated in FIG. 2 and described in the corresponding description.

In some embodiments, the KPI component 114 may be configured to construct/learn a plurality of key performance indicator (KPI) metrics, wherein each of the KPI metrics takes input comprising (1) the price adjustment multiplier applied to a given trip and (2) the rider coupon applied to a rider of the given trip, and generates output comprising a KPI value of the given trip, wherein the price adjustment multiplier and the rider coupon are factors in determining a price for the given trip. Exemplary KPI metrics may include a trip metric (trip conversion probability), a gross profit metric, a gross merchandise value (GMV) metric, another suitable KPI metric, or any combination thereof. For example, if fᵢ represents a trip conversion probability function (more accurately, a probability that an eyeball session converts to a trip), fᵢ may be learned and constructed with classification-type machine learning models such as logistic regression, random forest, or deep learning. The input features considered by the machine learning model may include both the price adjustment multipliers and personalized coupons (as they both are critical price-related features), as well as other features like origin, destination, time, trip distance, event, and features related to the user profile. As another example, for each trip order, the gross profit (sometimes called “net income” or “net inflow”) may be defined as profit=(rider_fare−driver_fare−coupon)*trip_conversion_probability, where the rider_fare is the charge for the rider, the driver_fare is the payment to the driver, the coupon is the discount for the rider in the form of a percentage (in which case, the coupon in the above equation may be converted to rider_fare*coupon_percentage) or a fixed amount, and the trip_conversion_probability is the afore-mentioned fᵢ that may be obtained by machine learning models as described above. In some embodiments, rider_fare may be determined by original_price*mᵤ+addtional_term, where the original price is calculated through estimated time and distance, multiplied with certain billing rates for time and distance respectively, and may be affected by various multiplicative factors such as surge multipliers, price increases (e.g., due to choosing multiple seats in carpool settings), mᵤ may refer to the price adjustment multiplier for the pricing unit that the trip belongs to, and the additional_term usually includes a sum of tolls and taxes. In some embodiments, the driver_fare may be calculated differently for single rider trips and carpool trips. As yet another example, the GMV metric may be defined as GMV=rider_fare*trip_conversion_probability, where the trip_conversion_probability is the afore-mentioned fᵢ that may be obtained by machine learning models as described above.

In some embodiments, the optimization component 116 may be configured to an optimization problem that maximizes a weighted sum of the plurality of KPI metrics with a vector of price-adjustment-multiplier decision variables and a matrix of rider-coupon decision variables, each of the price-adjustment-multiplier decision variables corresponding to one of the plurality of spatial-temporal pricing units, and each of the rider-coupon decision variables respectively corresponding to one of the plurality of rider segments within one of the plurality of spatial-temporal pricing units. In some embodiments, the optimization component 116 may be further configured to determine, by solving the optimization problem, a plurality of optimal price adjustment multipliers and a plurality of optimal rider coupons. The goal of solving the optimization problem is to determine optimal sets of price adjustment multipliers and rider coupons which maximize the KPI metrics that a ride-hailing platform is interested in. In some embodiments, the optimization problem may be represented by:

$${max}_{\vec{m} , \vec{c}} {Σ}_{i} {w}_{i} {\overline{f}}_{i} ( \vec{m} , \vec{c} ) \qquad ( 1 )$$

where \vec{m} refers to the vector of price adjustment multipliers, and \vec{c} refers to the vector (or matrix) of coupons. For example, \vec{m}:=[ma], where u is the spatial-temporal pricing unit for the multiplier mᵤ; and \vec{c}:=[cᵤₛ], where u is a spatial-temporal pricing unit, s is a rider segment, and cᵤₛ refers to a rider segment within the spatial-temporal pricing unit. The weights of formula (1) may be determined based on grid search, random search, or Bayesian optimization for maximizing the KPI metrics while considering the others as constraint requirements. In some embodiments, the weights of formula (1) may be dynamically changed. For example, a feedback loop may be designed to dynamically adapt the weights if the KPI metrics in the real world do not achieve the expected goal (e.g., if the increase of the number of trips is small but GMV increase is overachieved, the weight for the trip conversion probability may be increased accordingly).

In some embodiments, the deployment component 118 may be configured to deploy the price adjustment multipliers and the coupons when determining ride prices. For example, when a new ride request is received, the ride-hailing platform may determine the spatial-temporal pricing unit that the requested ride belongs to and the rider-segment that the rider of the ride request belongs to. The spatial-temporal pricing unit may be the basis for determining the price adjustment multiplier should be applied to this trip, and the rider segment may be the basis for determining the coupon should be granted to this rider.

FIG. 2 illustrates an exemplary diagram for segmenting riders for jointly determining optimal price adjustment multipliers and personalized coupons in a ride-hailing platform in accordance with various embodiments. In ride-hailing platforms, homogeneous riders may be granted the same coupon options (e.g., also called personalized coupons) since their reactions to coupons are similar. Therefore, the riders may be clustered into segments in order to determine coupons. In some embodiments, this clustering process may include a plurality of components: rider feature selection methods, segment distance metrics, and clustering algorithms. The clustering process may examine/evaluate various combinations of the above components (or a subset of the components) based on historical riders 210 to identify an optimal clustering method (also called user segmentation method).

In some embodiments, a plurality of rider features 220 may be extracted from the historical riders 210 for clustering/segmentation. These features may include each rider's historical ride information, aggregated versions of such historical ride information, and each riders' personal features, other suitable features, or any combination thereof. In some embodiments, the each rider's historical ride information may include the number of trips, average trip price, percentage of trips with a surge, the average surge of completed trips, percentage of trips with coupons, average coupon amount/percentage of completed trips, average road distance per trip, average time duration per trip, percentage of converted sessions, another suitable feature, or any combination thereof. In some embodiments, the aggregated versions of such historical ride information may include total numbers (e.g., in comparison the average numbers in the historical ride information), product types (e.g., single rides or carpool rides), time of day (e.g., the distribution of ride times in each day), day of the week (e.g., the distribution of ride days in each week), another suitable aggregation, or any combination thereof. In some embodiments, the each riders' personal features may include the number of years the rider has been using the app, most frequent payment method the rider used (cash, or credit cards), phone types such as Android or iOS, another suitable feature, or any combination thereof.

In some embodiments, the plurality of rider features 220 may include a large number of features in which some may be more effective than others in segmenting the riders under different scenarios. As such, clustering riders based on all the features may become unnecessary and in some cases impractical (e.g., for high computational cost). In some embodiments, various feature selection methods 230 may be applied to select a subset of the plurality of rider features 220 to reduce the dimensions and complexity. Exemplary methods include sparse principal components analysis (PCA) and greedy search in feature subset space. The sparse PCA may be used to generate principal components that have many zero loadings. The corresponding features with non-zero loadings from the first k principal components are considered as the most important features. When greedy search is used, Silhouette scores may be used to evaluate the clustering quality. The best feature subset may be selected by searching for the best Silhouette scores. Since the number of candidate solutions grows exponentially as the number of features increases, greedy search may be used to find a locally optimal feature subset. The greedy search strategies often used in feature selection include greedy forward selection, and greedy backward elimination.

In some embodiments, various distance metrics 240 may be adopted to determine whether two samples (e.g., two riders) should be clustered into one rider segment. Exemplary metrics include Euclidean distance, Weighted Euclidean distance, Cosine similarity metric, or another suitable distance metric.

In some embodiments, different clustering algorithms 250 may be adopted to cluster/segment the historical riders 210 based on a subset of the features 220 selected by the feature selection methods 230 and the distance metrics 240. Exemplary clustering algorithms 250 may include K-Means clustering, Mean-shift clustering, Density-base spatial clustering of applications with noise, or another suitable clustering algorithm.

A plurality of combinations of the feature selection methods 230, distance metrics 240, and the clustering algorithms 250 may respectively run against the plurality of historical riders 210 to generate a segmentation result. Different combinations may generate different segmentation results such as 260A and 260B.

In some embodiments, the segmentation results generated by the plurality of combinations may be evaluated based on a plurality of metrics in step 262. Some of the metrics may include distance measuring metrics to evaluate whether similar riders are clustered together and different riders are clustered into different segments. In some embodiments, some of the metrics may be designed to reflect the quality of the rider segments from the ride-hailing platform's perspective, such as whether the riders in different rider segments have different price elasticity (ideally, riders in different rider segments should have different price elasticity). In some embodiments, the price elasticity may represent price sensitivity. For example, a mean price elasticity difference may be used as a metric to determine whether riders with similar price elasticity are grouped together.

In some embodiments, the mean price elasticity difference of a segmentation result may be obtained by: for each of the plurality of historical rider segments in the each rider segmentation result: dividing a plurality of historical requests from riders in the each rider segment into a plurality of price bins based on prices shown to the rider; obtaining a conversion rate for each of the plurality of price bins, wherein the conversion rate represents a percentage of the historical requests in the each price bin have converted to trips; and obtaining a price elasticity based on the plurality of price bins of the each historical rider segment and the plurality of corresponding conversion percentages; and for each of the plurality of rider segmentation results, determining the mean price elasticity difference based on the plurality of price elasticities of the plurality of historical rider segments in the each rider segmentation result.

For example, the mean price elasticity difference may be determined by three steps: data preparation, elasticity calculation, and mean price elasticity difference calculation. During the data preparation step, the historical requests from riders with each rider segment may be processed parallelly (since they are independent from each other) to obtain a plurality of prices and a plurality of ride conversion rates for each rider segment. Here, the “price” may refer to the price shown to the rider by the ride-hailing platform, and the “ride conversion rate” may refer to a percentage of requests that have converted into trips. For example, the price data of the historical requests may be discretized into a few bins (e.g., 10 bins), and the price for each bin is calculated as the midpoint of the bin. The percentage of ride requests converted to trips is calculated for each price bin.

After the prices and conversion rates are prepared for each rider segment, an elasticity measuring model may be fit based on the prices and conversion rates. For example, denoting Pₛ and Rₛ as the price and conversion rate for segment s, respectively, the following model may be learned for each rider segment s:

log(Rₛ)˜aₛ+bₛ log(Pₛ)

where bₛ is the elasticity for rider segment s.

Once the elasticity measuring models for all the rider segments are learned, the mean price elasticity difference for the segmentation result may be determined by:

$$\frac{2}{{N}_{S} ( {N}_{s} - 1 )} {\sum }_{s 1 > s 2} \vert {b}_{s 1} - {b}_{s 2} \vert ,$$

where N_{S} is the number of segments, s1 and s2 refer to the indexes of two different rider segments, and “s1>s2” may indicate the mean price elasticity difference may take into account of all the elasticity values between each s1 (each rider segment in the segmentation result) and all the rider segments that have smaller indexes in the segmentation result.

In some embodiments, the evaluation step 262 may include other metrics such as a Silhouette score that measures how similar a sample (a rider) is to the samples in the same rider segment as compared to the samples in the nearest rider segment. For example, the similarity between a rider i to the riders in the same rider segment may be calculated as

$${D}_{same} ( i ) = \frac{1}{\vert {S}_{i} \vert} {\sum }_{j ∈ {S}_{i} , i \neq j} d ( i , j )$$

and the similarity between a rider i to the riders in the nearest cluster may be calculated as:

$${D}_{other} ( i ) = min \frac{1}{\vert {S}_{k} \vert} {\sum }_{j ∈ {S}_{k}} d ( i , j )$$

where d refers to a metric measuring the similarity between every two riders, and ISI refers to the number of riders in the rider segment S. Based on the above denotations, the Silhouette score for a rider i may be calculated as:

$$Silhouette Score ( i ) = \frac{{D}_{other} ( i ) - {D}_{same} ( i )}{max \{ {D}_{other} ( i ) , {D}_{same} ( i ) \}}$$

where the Silhouette score is set to 0 when the rider segment of rider i only has one rider. Subsequently, the Silhouette score for the segmentation result may be calculated as a simple average of all the Silhouette scores for all the riders in the segmentation result.

In some embodiments, a minimum user segment size may be taken into consideration. For example, a minimum number of riders in each rider segment may be defined. In some embodiments, if a segmentation result includes a rider segment with a size smaller than the minimum user segment size, it may be given a low score indicating the segmentation method is ineffective. In some embodiments, rider segments smaller that the size may be treated as invalid and combined with one or more nearest rider segments to form valid rider segments.

Based on a weighted sum of one or more of the above-mentioned evaluation scores for each of the segmentation results, the optimal combination of one of the feature selection methods 230, one of the distance metrics 240, and one of the clustering algorithms 250 to cluster/segment new riders may be determined, which may be referred to as the optimal clustering method for clustering/segmenting new riders.

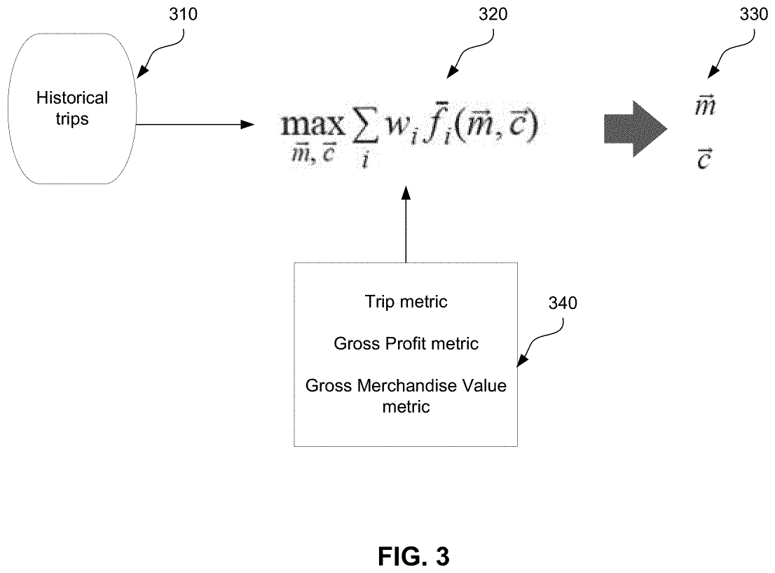

FIG. 3 illustrates an exemplary optimization problem formulation for jointly determining optimal price adjustment multipliers and personalized coupons in a ride-hailing platform in accordance with various embodiments. The optimization problem 320 in FIG. 3 may be designed in different ways, depending on the implementation. For illustrative purposes, formula (1) is used as an example to describe how the optimization problem 320 is constructed and solved to obtain optimal price adjustment multipliers and personalized coupons in a ride-hailing platform.

In some embodiments, the optimization problem 320 may be constructed to maximize a weighted sum of the plurality of KPI metrics with a plurality of decision variables 330. The decision variables 330 may include a vector of price-adjustment-multiplier decision variables and a matrix of rider-coupon decision variables, each of the vector of price-adjustment-multiplier decision variables corresponding to one of the plurality of spatial-temporal pricing units, and each of the matrix of rider-coupon decision variables respectively corresponding to one of the plurality of rider segments within one of the plurality of spatial-temporal pricing units.

For example, the vector of price adjustment multipliers may be denoted as \vec{m}: =[mᵤ], where u is a spatial-temporal pricing unit, and when the optimization problem 320 is solved, mᵤ is the optimal price adjustment multiplier for the u pricing unit. Similarly, the matrix of rider-coupon decision variables may be denoted as \vec{c}: =[cᵤₛ], where u is still the spatial-temporal pricing unit, s is a rider segment, and when the optimization problem 320 is solved, cᵤₛ is the optimal coupon for the rider in the s rider segment and the rider's request/trip belongs to the u pricing unit.

In some embodiments, the f̅ᵢ(\vec{m}, ĉ) in the optimization problem 320 may refer to an i-th KPI metric 340 that the ride-hailing platform hopes to optimize. Exemplary KPI metrics 340 may include trips, profit, GMV, another suitable KPI metric, or any combination thereof. These KPI metrics 340 may be learned by various machine learning models fitting historical data. For example the trip metric (trip conversion probability) may be constructed as a neural network that learns a relationship (e.g., a function) between a plurality of price-related features (such as the price adjustment multipliers and the coupons) and the probability that ride requesting sessions convert to trips. With these trained or learned KPI models, historical trip information 310 (e.g., including historical ride requesting sessions and trips) may be input into the models to obtain actual KPI values.

In some embodiments, the f̅ᵢ(\vec{m}, \vec{c}) in the optimization problem 320 may be represented as: f̅ᵢ(\vec{m}, c̅)=Σᵤ Σₛ fᵢᵤₛ(mᵤ, cᵤₛ), where each inner sum (corresponding to each pricing unit u) may be independently calculated. That is, solving the optimization problem 320 comprises: parallelly determining values of the plurality of KPI metrics for each of the plurality of spatial-temporal pricing units with a parallel-programming architecture, such as a Spark framework, a Metacomputer Adaptive Runtime System (MARS) framework, a map-reduce framework, and one or more GPUs.

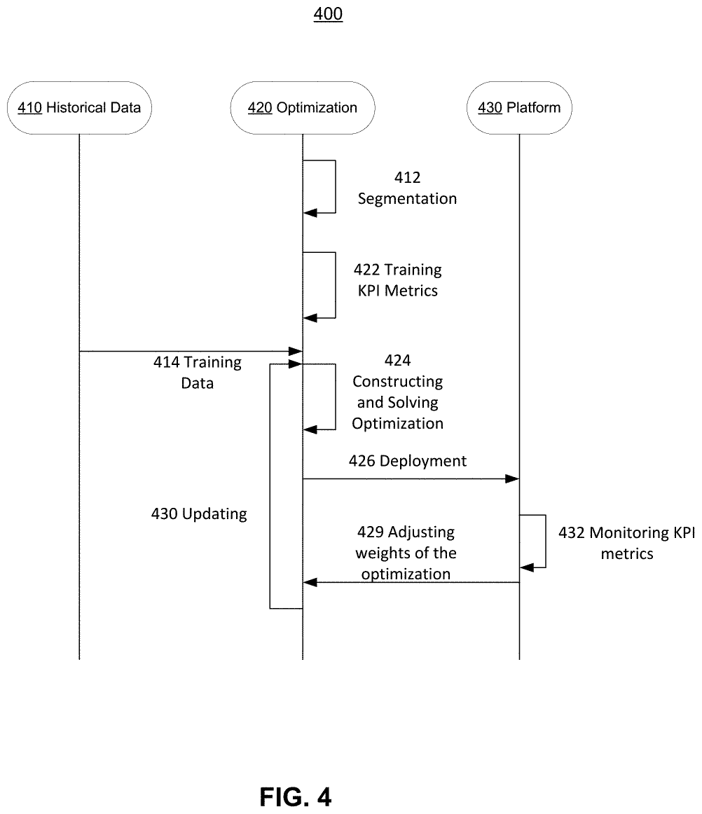

FIG. 4 illustrates an exemplary flow chart of a method 400 for jointly determining optimal price adjustment multipliers and personalized coupons in a ride-hailing platform in accordance with various embodiments. The method 400 is merely illustrative. Depending on the implementation, the method 400 may have more, fewer, or alternative steps or components. The method 400 may be implemented by the computing system 102 in FIG. 1.

The exemplary method 400 in FIG. 4 involves historical trip information component 410, an optimization component 420, and a ride-hailing platform 430. In some embodiments, the historical trip information component 410 may include historical ride requesting sessions, historical riders, and historical trips, and may be sent to the optimization component 420 as training data at step 414. The training data may be used at different phases within the optimization component 420 as described below.

In some embodiments, the optimization component 420 may perform a plurality of tasks: determining an optimal rider segmenting/clustering method 412, training one or more models for one or more KPI metrics 422, and constructing and solving an optimization model 424. Depending on the implementation, the optimization component 420 may include more, fewer, or alternative tasks. For example, some tasks (e.g., rider segmentation 412) may be implemented by another entity other than the optimization component 420.

During the rider segmentation step 412, a plurality of rider segmentation methods are evaluated. Each of the plurality of rider segmentation methods may include a feature selection method, a distance measuring metric, and a clustering algorithm to generate a segmentation result, which may include a plurality of rider segments of the plurality of historical riders from the historical data 410. The plurality of segmentation results may be evaluated based on a plurality of evaluation metrics, including Silhouette scores of riders in each of the segmentation result, mean price elasticity difference the plurality of rider segments in each of the segmentation result, and minimum segment size. The combination that generates the optimal segmentation result may be deployed as the optimal clustering method to segment the riders. Comparing to traditional clustering/segmentation evaluation methods, the mean price elasticity difference metric provides a business-oriented metric to evaluate the segmentation results.

During the KPI metric training/learning step 422, the historical trip information from the historical data in 410 may be used to fit various models. For instance, a classifier may be trained based on the historical trip information to predict trip conversion probabilities for given price adjustment multipliers and rider coupons. As shown in formula (1), each of the KPI metrics may be associated with a weight. These weights may be static or dynamic. For example, a feedback loop may be designed to dynamically adapt the weights if in the real world, the metrics do not achieve expected goals (e.g., increasing the weight of a KPI metric when it is below expectation). The adjustment cycle does not have to be real-time. The computing system of the ride-hailing platform may monitor the metrics for a certain period of time and make corresponding adjustments.

During the optimization problem construction and solving step 424, the formula (1) may be solved, for example, by commercial solvers, or mathematically. The constraints for the formula (1) may involve range constraints of the price adjustment multipliers and rider coupons. The solutions of the formula (1) may include determined optimal values for the decision variables, including a vector of price adjustment multipliers and the rider coupons that maximize the weighted sum of the KPI metrics.

These optimal values for the decision variables may be deployed to the ride-hailing platform 430 at step 426 to determine prices for pending ride requests. This way, the price adjustment multipliers and the rider coupons are learned jointly to optimize the ride-hailing platform's goals. In some embodiments, at step 432, the ride-hailing platform 430 may monitor whether one or more KPI metrics meet expectations after the deployment 426 of the price adjustment multipliers and the rider coupons. If a KPI metric fails to meet the corresponding expectation, the optimization component 420 may accordingly adjust the weight of the KPI metric at step 429 and update the optimization problem at step 430. The updated optimization problem may be solved to provide updated price adjustment multipliers and rider coupons.

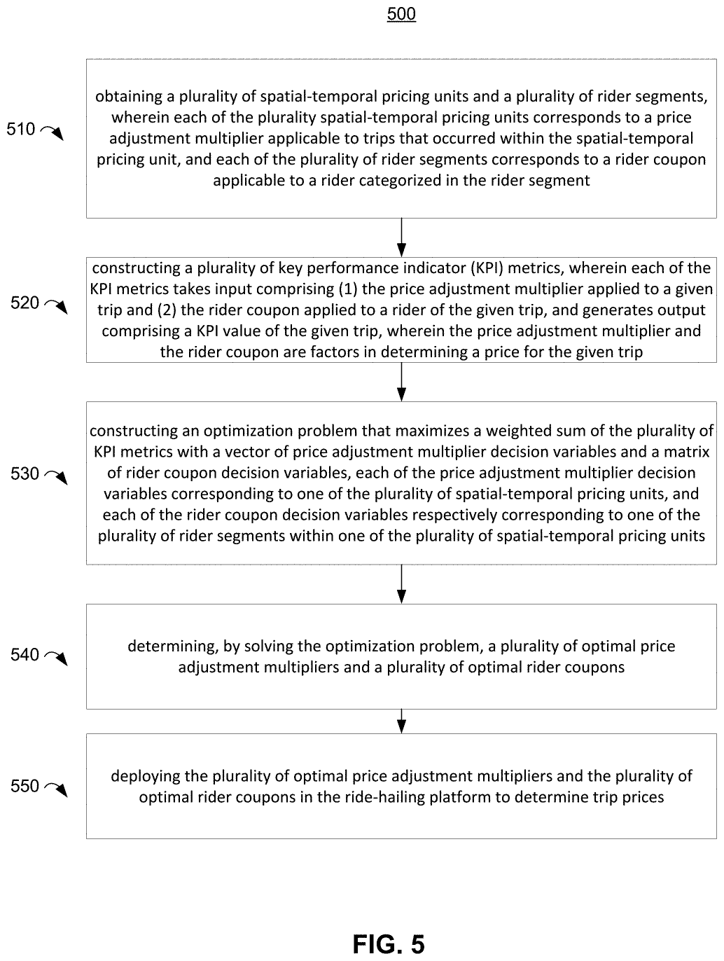

FIG. 5 illustrates an exemplary method 500 for jointly determining optimal price adjustment multipliers and personalized coupons in a ride-hailing platform in accordance with various embodiments. The method 500 may be implemented in an environment shown in FIG. 1. The method 500 may be performed by a device, apparatus, or system illustrated by FIGS. 1-4, such as the system 102. Depending on the implementation, the method 500 may include additional, fewer, or alternative steps performed in various orders or in parallel.

Block 510 includes obtaining a plurality of spatial-temporal pricing units and a plurality of rider segments, wherein each of the plurality spatial-temporal pricing units corresponds to a price adjustment multiplier applicable to trips that occur within the spatial-temporal pricing unit, and each of the plurality of rider segments corresponds to a rider coupon applicable to a rider in the rider segment. In some embodiments, the obtaining a plurality of rider segments comprises: obtaining a plurality of rider segmentation results by respectively applying a plurality of clustering methods to segment a plurality of historical riders based on a plurality of rider features; for each of the plurality of rider segmentation results, obtaining an evaluation score based on a weighted sum of a plurality of evaluation metrics; and identifying one of the plurality of clustering methods corresponding to a smallest evaluation score; and deploying the identified clustering method to segment new riders.

In some embodiments, each of the plurality of rider segmentation results comprise a plurality of historical rider segments, and the plurality of evaluation metrics comprise a mean price elasticity metric that measures price elasticity of each of the plurality of rider segmentation results by: for each of the plurality of historical rider segments in the each rider segmentation result: dividing a plurality of historical requests from riders in the each rider segment into a plurality of price bins based on prices shown to the rider; obtaining a conversion rate for each of the plurality of price bins, wherein the conversion rate represents a percentage of the historical requests in the each price bin that have converted to trips; and obtaining a price elasticity based on the plurality of price bins of the each historical rider segment and the plurality of corresponding conversion rates; and for each of the plurality of rider segmentation results, determining the mean price elasticity difference based on the plurality of price elasticities of the plurality of historical rider segments in the each rider segmentation result.

In some embodiments, the plurality of clustering methods are determined by: determining a plurality of feature selection methods; determining a plurality of distance metrics to measure clustering distances between the riders; determining a plurality of clustering algorithms; and obtaining the plurality of clustering methods as a plurality of combinations of the plurality of feature selection methods, the plurality of distance metrics, and the plurality of clustering algorithms.

In some embodiments, the plurality of rider features comprise: a rider's historical trip information comprising at least one of the following: an average trip price, an average surge of completed trips, an average coupon of the completed trips, a percentage of converted sessions; and the rider's persona information comprising at least one of the following: a number of years the rider has been using the ride-hailing platform, frequent payment methods, and information of the rider's smart device.

In some embodiments, the plurality of evaluation metrics comprise a Silhouette score measuring a similarity of a rider to other riders in a same historical rider segment as compared to riders in a different historical rider segment. In some embodiments, the rider coupon is a discount amount or a discount percentage.

Block 520 includes constructing a plurality of key performance indicator (KPI) metrics, wherein each of the KPI metrics takes input comprising (1) the price adjustment multiplier applied to a given trip and (2) the rider coupon applied to a rider of the given trip, and generates output comprising a KPI value of the given trip, wherein the price adjustment multiplier and the rider coupon are factors in determining a price for the given trip.

In some embodiments, the plurality of key performance indicator (KPI) metrics comprises at least two of the following: a trip conversion rate metric, a gross profit metric, and a gross merchandise value metric. In some embodiments, the trip conversion rate metric comprises a trained classification-type machine learning model that predicts a probability that a rider's request converts to a trip based at least on the price adjustment multiplier and the rider coupon applied to the request.

Block 530 includes constructing an optimization problem that maximizes a weighted sum of the plurality of KPI metrics with a vector of price-adjustment-multiplier decision variables and a matrix of rider-coupon decision variables, each of the price-adjustment-multiplier decision variables corresponding to one of the plurality of spatial-temporal pricing units, and each of the rider-coupon decision variables respectively corresponding to one of the plurality of rider segments within one of the plurality of spatial-temporal pricing units.

Block 540 includes determining, by solving the optimization problem, a plurality of optimal price adjustment multipliers and a plurality of optimal rider coupons. In some embodiments, the solving the optimization problem comprises: parallelly determining values of the plurality of KPI metrics for each of the plurality of spatial-temporal pricing units with a parallel-programming architecture. In some embodiments, the parallel-programming architecture comprises at least one of the following: a Spark framework, a Metacomputer Adaptive Runtime System (MARS) framework, a map reduce framework, and one or more GPUs.

Block 550 includes deploying the plurality of optimal price adjustment multipliers and the plurality of optimal rider coupons in the ride-hailing platform to determine trip prices.

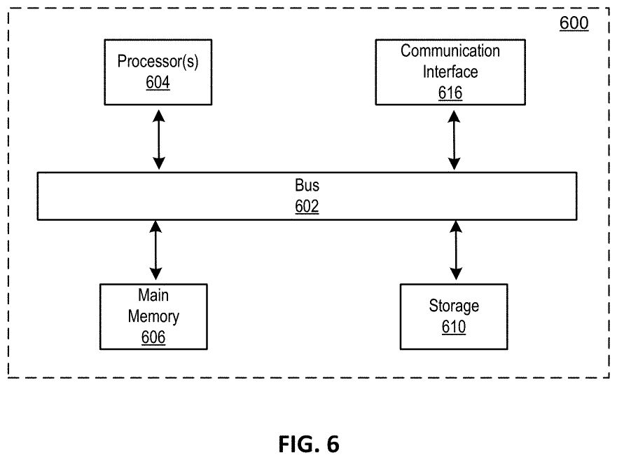

FIG. 6 illustrates an example computing device in which any of the embodiments described herein may be implemented. The computing device may be used to implement one or more components of the systems and the methods shown in FIGS. 1-7. The computing device 600 may comprise a bus 602 or other communication mechanism for communicating information and one or more hardware processors 604 coupled with bus 602 for processing information. Hardware processor(s) 604 may be, for example, one or more general purpose microprocessors.

The computing device 600 may also include a main memory 606, such as a random-access memory (RAM), cache and/or other dynamic storage devices 610, coupled to bus 602 for storing information and instructions to be executed by processor(s) 604. Main memory 606 also may be used for storing temporary variables or other intermediate information during execution of instructions to be executed by processor(s) 604. Such instructions, when stored in storage media accessible to processor(s) 604, may render computing device 600 into a special-purpose machine that is customized to perform the operations specified in the instructions. Main memory 606 may include non-volatile media and/or volatile media. Non-volatile media may include, for example, optical or magnetic disks. Volatile media may include dynamic memory. Common forms of media may include, for example, a floppy disk, a flexible disk, hard disk, solid state drive, magnetic tape, or any other magnetic data storage medium, a CD-ROM, any other optical data storage medium, any physical medium with patterns of holes, a RAM, a DRAM, a PROM, and EPROM, a FLASH-EPROM, NVRAM, any other memory chip or cartridge, or networked versions of the same.

The computing device 600 may implement the techniques described herein using customized hard-wired logic, one or more ASICs or FPGAs, firmware and/or program logic which in combination with the computing device may cause or program computing device 600 to be a special-purpose machine. According to one embodiment, the techniques herein are performed by computing device 600 in response to processor(s) 604 executing one or more sequences of one or more instructions contained in main memory 606. Such instructions may be read into main memory 606 from another storage medium, such as storage device 610. Execution of the sequences of instructions contained in main memory 606 may cause processor(s) 604 to perform the process steps described herein. For example, the processes/methods disclosed herein may be implemented by computer program instructions stored in main memory 606. When these instructions are executed by processor(s) 604, they may perform the steps as shown in corresponding figures and described above. In alternative embodiments, hard-wired circuitry may be used in place of or in combination with software instructions.

The computing device 600 also includes a communication interface 616 coupled to bus 602. Communication interface 616 may provide a two-way data communication coupling to one or more network links that are connected to one or more networks. As another example, communication interface 616 may be a local area network (LAN) card to provide a data communication connection to a compatible LAN (or WAN component to communicate with a WAN). Wireless links may also be implemented.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

When the functions disclosed herein are implemented in the form of software functional units and sold or used as independent products, they can be stored in a processor executable non-volatile computer-readable storage medium. Particular technical solutions disclosed herein (in whole or in part) or aspects that contribute to current technologies may be embodied in the form of a software product. The software product may be stored in a storage medium, comprising a number of instructions to cause a computing device (which may be a personal computer, a server, a network device, and the like) to execute all or some steps of the methods of the embodiments of the present application. The storage medium may comprise a flash drive, a portable hard drive, ROM, RAM, a magnetic disk, an optical disc, another medium operable to store program code, or any combination thereof.

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

Embodiments disclosed herein may be implemented through a cloud platform, a server or a server group (hereinafter collectively the “service system”) that interacts with a client. The client may be a terminal device, or a client registered by a user at a platform, wherein the terminal device may be a mobile terminal, a personal computer (PC), and any device that may be installed with a platform application program.

The various features and processes described above may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The exemplary systems and components described herein may be configured differently than described. For example, elements may be added to, removed from, or rearranged compared to the disclosed example embodiments.

The various operations of exemplary methods described herein may be performed, at least partially, by an algorithm. The algorithm may be comprised in program codes or instructions stored in a memory (e.g., a non-transitory computer-readable storage medium described above). Such algorithm may comprise a machine learning algorithm. In some embodiments, a machine learning algorithm may not explicitly program computers to perform a function but can learn from training data to make a prediction model that performs the function.

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, “or” is inclusive and not exclusive, unless expressly indicated otherwise or indicated otherwise by context. Therefore, herein, “A, B, or C” means “A, B, A and B, A and C, B and C, or A, B, and C,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The term “include” or “comprise” is used to indicate the existence of the subsequently declared features, but it does not exclude the addition of other features. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

1. A computer-implemented method, the method comprising:
obtaining a plurality of spatial-temporal pricing units and a plurality of rider segments, wherein each of the plurality spatial-temporal pricing units corresponds to a price adjustment multiplier applicable to trips that occur within the spatial-temporal pricing unit, and each of the plurality of rider segments corresponds to a rider coupon applicable to a rider in the rider segment;
constructing a plurality of key performance indicator (KPI) metrics, wherein each of the KPI metrics takes input comprising (1) the price adjustment multiplier applied to a given trip and (2) the rider coupon applied to a rider of the given trip, and generates output comprising a KPI value of the given trip, wherein the price adjustment multiplier and the rider coupon are factors in determining a price for the given trip;
constructing an optimization model that maximizes a weighted sum of the plurality of KPI metrics with a vector of price-adjustment-multiplier decision variables and a matrix of rider-coupon decision variables, each of the price-adjustment-multiplier decision variables corresponding to one of the plurality of spatial-temporal pricing units, and each of the rider-coupon decision variables respectively corresponding to one of the plurality of rider segments within one of the plurality of spatial-temporal pricing units;
determining, by solving the optimization model, a plurality of optimal price adjustment multipliers and a plurality of optimal rider coupons; and
deploying the plurality of optimal price adjustment multipliers and the plurality of optimal rider coupons in the ride-hailing platform to determine trip prices.

2. The method of claim 1, wherein the obtaining a plurality of rider segments comprises:
obtaining a plurality of rider segmentation results by respectively applying a plurality of clustering methods to segment a plurality of historical riders based on a plurality of rider features;
for each of the plurality of rider segmentation results, obtaining an evaluation score based on a weighted sum of a plurality of evaluation metrics; and
identifying one of the plurality of clustering methods corresponding to a smallest evaluation score; and
deploying the identified clustering method to segment new riders.

3. The method of claim 2, wherein each of the plurality of rider segmentation results comprise a plurality of historical rider segments, and
the plurality of evaluation metrics comprise a mean price elasticity metric that measures price elasticity of each of the plurality of rider segmentation results by:
for each of the plurality of historical rider segments in the each rider segmentation result:
dividing a plurality of historical requests from riders in the each rider segment into a plurality of price bins based on prices shown to the rider;
obtaining a conversion rate for each of the plurality of price bins, wherein the conversion rate represents a percentage of the historical requests in the each price bin that have converted to trips; and
obtaining a price elasticity based on the plurality of price bins of the each historical rider segment and the plurality of corresponding conversion rates; and
for each of the plurality of rider segmentation results, determining the mean price elasticity difference based on the plurality of price elasticities of the plurality of historical rider segments in the each rider segmentation result.

4. The method of claim 2, wherein the plurality of clustering methods are determined by:
determining a plurality of feature selection methods;
determining a plurality of distance metrics to measure clustering distances between the riders;
determining a plurality of clustering algorithms; and
obtaining the plurality of clustering methods as a plurality of combinations of the plurality of feature selection methods, the plurality of distance metrics, and the plurality of clustering algorithms.

5. The method of claim 2, wherein the plurality of rider features comprise:
a rider's historical trip information comprising at least one of the following: an average trip price, an average surge of completed trips, an average coupon of the completed trips, a percentage of converted sessions; and
the rider's personal information comprising at least one of the following: a number of years the rider has been using the ride-hailing platform, frequent payment methods, and information of the rider's smart device.

6. The method of claim 2, wherein the plurality of evaluation metrics comprise a Silhouette score measuring a similarity of a rider to other riders in a same historical rider segment as compared to riders in a different historical rider segment.

7. The method of claim 1, wherein the plurality of key performance indicator (KPI) metrics comprises at least one of the following: a trip conversion rate metric, a gross profit metric, or a gross merchandise value metric.

8. The method of claim 7, wherein the trip conversion rate metric comprises a trained classification-type machine learning model that predicts a probability that a rider's request converts to a trip based at least on the price adjustment multiplier and the rider coupon applied to the request.

9. The method of claim 1, wherein the rider coupon is a discount amount or a discount percentage.

10. The method of claim 1, wherein the solving the optimization model comprises:
parallelly determining values of the plurality of KPI metrics for each of the plurality of spatial-temporal pricing units with a parallel-programming architecture.

11. The method of claim 10, wherein the parallel-programming architecture comprises at least one of the following: a Spark framework, a Metacomputer Adaptive Runtime System (MARS) framework, a map-reduce framework, and one or more GPUs.

12. A system comprising one or more processors and one or more non-transitory computer-readable memories coupled to the one or more processors, the one or more non-transitory computer-readable memories storing instructions that, when executed by the one or more processors, cause the system to perform operations comprising:
obtaining a plurality of spatial-temporal pricing units and a plurality of rider segments, wherein each of the plurality spatial-temporal pricing units corresponds to a price adjustment multiplier applicable to trips that occur within the spatial-temporal pricing unit, and each of the plurality of rider segments corresponds to a rider coupon applicable to a rider in the rider segment;
constructing a plurality of key performance indicator (KPI) metrics, wherein each of the KPI metrics takes input comprising (1) the price adjustment multiplier applied to a given trip and (2) the rider coupon applied to a rider of the given trip, and generates output comprising a KPI value of the given trip, wherein the price adjustment multiplier and the rider coupon are factors in determining a price for the given trip;
constructing an optimization model that maximizes a weighted sum of the plurality of KPI metrics with a vector of price-adjustment-multiplier decision variables and a matrix of rider-coupon decision variables, each of the price-adjustment-multiplier decision variables corresponding to one of the plurality of spatial-temporal pricing units, and each of the rider-coupon decision variables respectively corresponding to one of the plurality of rider segments within one of the plurality of spatial-temporal pricing units;
determining, by solving the optimization model, a plurality of optimal price adjustment multipliers and a plurality of optimal rider coupons; and
deploying the plurality of optimal price adjustment multipliers and the plurality of optimal rider coupons in the ride-hailing platform to determine trip prices.

13. The system of claim 12, wherein the obtaining a plurality of rider segments comprises:
obtaining a plurality of rider segmentation results by respectively applying a plurality of clustering methods to segment a plurality of historical riders based on a plurality of rider features;
for each of the plurality of rider segmentation results, obtaining an evaluation score based on a weighted sum of a plurality of evaluation metrics; and
identifying one of the plurality of clustering methods corresponding to a smallest evaluation score; and
deploying the identified clustering method to segment new riders.

14. The system of claim 13, wherein each of the plurality of rider segmentation results comprise a plurality of historical rider segments, and
the plurality of evaluation metrics comprise a mean price elasticity metric that measures price elasticity of each of the plurality of rider segmentation results by:
for each of the plurality of historical rider segments in the each rider segmentation result:
dividing a plurality of historical requests from riders in the each rider segment into a plurality of price bins based on prices shown to the rider;
obtaining a conversion rate for each of the plurality of price bins, wherein the conversion rate represents a percentage of the historical requests in the each price bin that have converted to trips; and
obtaining a price elasticity based on the plurality of price bins of the each historical rider segment and the plurality of corresponding conversion rates; and
for each of the plurality of rider segmentation results, determining the mean price elasticity difference based on the plurality of price elasticities of the plurality of historical rider segments in the each rider segmentation result.

15. The system of claim 12, wherein the plurality of key performance indicator (KPI) metrics comprises at least one of the following: a trip conversion rate metric, a gross profit metric, or a gross merchandise value metric.

16. The system of claim 12, wherein the solving the optimization model comprises:
parallelly determining values of the plurality of KPI metrics for each of the plurality of spatial-temporal pricing units with a parallel-programming architecture.

17. A non-transitory computer-readable storage medium storing instructions that, when executed by one or more processors, cause the one or more processors to perform operations comprising:
obtaining a plurality of spatial-temporal pricing units and a plurality of rider segments, wherein each of the plurality spatial-temporal pricing units corresponds to a price adjustment multiplier applicable to trips that occur within the spatial-temporal pricing unit, and each of the plurality of rider segments corresponds to a rider coupon applicable to a rider in the rider segment;
constructing a plurality of key performance indicator (KPI) metrics, wherein each of the KPI metrics takes input comprising (1) the price adjustment multiplier applied to a given trip and (2) the rider coupon applied to a rider of the given trip, and generates output comprising a KPI value of the given trip, wherein the price adjustment multiplier and the rider coupon are factors in determining a price for the given trip;
constructing an optimization model that maximizes a weighted sum of the plurality of KPI metrics with a vector of price-adjustment-multiplier decision variables and a matrix of rider-coupon decision variables, each of the price-adjustment-multiplier decision variables corresponding to one of the plurality of spatial-temporal pricing units, and each of the rider-coupon decision variables respectively corresponding to one of the plurality of rider segments within one of the plurality of spatial-temporal pricing units;
determining, by solving the optimization model, a plurality of optimal price adjustment multipliers and a plurality of optimal rider coupons; and
deploying the plurality of optimal price adjustment multipliers and the plurality of optimal rider coupons in the ride-hailing platform to determine trip prices.

18. The storage medium of claim 17, wherein the obtaining a plurality of rider segments comprises:
obtaining a plurality of rider segmentation results by respectively applying a plurality of clustering methods to segment a plurality of historical riders based on a plurality of rider features;
for each of the plurality of rider segmentation results, obtaining an evaluation score based on a weighted sum of a plurality of evaluation metrics; and
identifying one of the plurality of clustering methods corresponding to a smallest evaluation score; and
deploying the identified clustering method to segment new riders.

19. The storage medium of claim 18, wherein each of the plurality of rider segmentation results comprise a plurality of historical rider segments, and
the plurality of evaluation metrics comprise a mean price elasticity metric that measures price elasticity of each of the plurality of rider segmentation results by:
for each of the plurality of historical rider segments in the each rider segmentation result:
dividing a plurality of historical requests from riders in the each rider segment into a plurality of price bins based on prices shown to the rider;
obtaining a conversion rate for each of the plurality of price bins, wherein the conversion rate represents a percentage of the historical requests in the each price bin that have converted to trips; and
obtaining a price elasticity based on the plurality of price bins of the each historical rider segment and the plurality of corresponding conversion rates; and
for each of the plurality of rider segmentation results, determining the mean price elasticity difference based on the plurality of price elasticities of the plurality of historical rider segments in the each rider segmentation result.

20. The storage medium of claim 17, wherein the plurality of key performance indicator (KPI) metrics comprises at least one of the following: a trip conversion rate metric, a gross profit metric, or a gross merchandise value metric.
